(19) United States
(12) Patent Application Publication
(10) Pub. No.: US 2006/0186721 A1
(43) Pub. Date: Aug. 24, 2006

(54) Vehicle seat with an adjustable leg rest

(76) Inventors: Gerhard Flory, Annweiler (DE); Hans Edrich, Heltersberg (DE); Gunter Franzman, Rockenhausen (DE); Klaus Hassler, Mehlach (DE); Heiko Utsch, Kaiserslautern (DE); Andreas Weingart, Niederkirchen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/506,496

(22) PCT Filed: Feb. 8, 2003
(86) PCT No.: PCT/EP03/01266

§ 371 Date: May 24, 2005

(30) Foreign Application Priority Data
Mar. 4, 2002 (DE) 102 09 185.4

(51) Int. Cl. B60N 2/44; A47C 7/50

(52) U.S. Cl. 297/423.36; 297/423.3

(57) ABSTRACT

A reclinable vehicle seat, which is freely adjustable between an upright sitting position and a reclined resting position, has a backrest with an adjustable inclination, a seat cushion with adjustable sitting depth and a lower leg rest. In order to obtain a support which is as comfortable as possible and a compact design, the inclination of the seat cushion is adjustable by an inclination adjuster, and the seat cushion has a continuous seat upholstered element which upholsters the seat cushion and the lower leg rest.

This application claims the priority of German application No. 10209185.4, filed Mar. 4, 2002, and PCT International Patent Application No. PCT/EP03/01266, filed Feb. 8, 2003, the disclosure of which is expressly incorporated by reference herein.

### BACKGROUND AND SUMMARY OF THE INVENTION

The invention relates to a reclinable vehicle seat which has an upright sitting position and a reclined resting position and which can be adjusted in an infinitely variable fashion, preferably driven automatically, between the sitting position and the resting position, having a backrest whose inclination can be adjusted, and having a seat cushion with adjustable sitting depth and a lower leg rest.

German laid-open patent application 24 01 241 discloses a rear seat for vehicles. The seat has a backrest which can be inclined by means of the reclining seat fitting and an extendable footrest. This seat can be moved from an upright sitting position into a lying position by inclining the backrest and extending the footrest. However, in the lying position, the seat provides only insufficient support to the body and thus inadequate comfort. In particular, very large and/or very small persons are only insufficiently supported in the lying position.

DE 100 09 228 A1 discloses a vehicle seat which has a sitting depth adjustment means. In the front region of the seat surface, an adjustment element is let in, which element can be moved between an extended position which increases the sitting depth and a retracted position with a small sitting depth. However, this seat only provides one upright sitting position, which is not very restful.

DE 198 01 893 A1 discloses a further motor vehicle seat with adjustable sitting depth. The latter has an upholstered seat element which is pulled downward around the front edge of the sitting surface as a sitting depth reserve, which can be correspondingly extended or retracted when the sitting depth is adjusted. This seat also provides only one upright sitting position.

The object of the invention is to provide a vehicle seat which is of compact design and has a high level of comfort. In particular, the seat is to have an equally high level of comfort for persons of different sizes.

The object is achieved according to the invention by means of a reclinable vehicle seat with the following features.

The vehicle seat has a seat cushion which has an adjustable sitting depth and an adjustable inclination. In combination with a backrest whose inclination is adjustable and an adjustable lower leg rest, a variety of adjustment possibilities of the seat are thus obtained. When the lower leg rest is folded away and/or the back rest is in the upright position and/or the seat cushion is level, the vehicle seat has a comfortable upright sitting position. If the backrest is moved into the resting position, the sitting surface is inclined and the lower leg rest is raised, a comfortable lying and/or resting position of the vehicle seat is obtained.

A large number of possible sitting and lying positions can be set by virtue of the infinitely variable adjustability of the individual seat components such as the backrest, seat cushion and lower leg rest. As a result, both large persons and small persons can freely set the position which is most comfortable for them. The seat cushion has a continuous seat upholstered element which is designed to upholster the lower leg rest and the seat cushion. As a result, a continuously upholstered sitting surface is formed which does not have any gap and as a result provides comfortable support to the sitting person, in particular to the upper and lower parts of the leg. The seat upholstered element preferably has an enclosed upholstered surface with a cover, for example made of leather and/or material and/or plastic. In order to take up as little installation space as possible in a comfortable, upright sitting position, the lower leg rest is designed in such a way that it has a space-saving stowaway position and an extended position of use. In the stowaway position, the lower leg rest can be arranged lying closely against the seat cushion so that an upright sitting position is possible without at the same time having to accept an adverse effect on the available foot space.

The vehicle seat can be adjusted in an optimum fashion by virtue of the fact that the body is supported with an adjustable seat cushion and the lower leg rest adjoins without a gap. Persons of different sizes can always set the seat in such a way that it has a sitting surface which is precisely matched to the respective body mass. This setting has a very large supporting surface between the sitting person and the seat, and is perceived as the most comfortable setting by the sitting person as a result of the provision of support to the entire body. At the same time, in the event of a crash the sitting person is also very well protected since the forces which occur can be absorbed by the seat upholstered element and the backrest over a large surface owing to the fact that the body is supported over a large surface.

There is provision for one end of the seat upholstered element to be permanently connected to the seat cushion, in particular in the region of the backrest, and for the other end of the seat upholstered element to be connected to the lower leg rest by a carriage which is displaceably mounted on the lower leg rest. When the sitting depth and/or the inclination are adjusted, the seat upholstered element is moved in relation to the sitting surface. Owing to the displaceably mounted carriage, the seat upholstered element can then move so that excessively strong clamping and/or hardening as a result of the seat upholstered element being compressed are avoided.

In one embodiment there is provision for a force which is as constant as possible to be applied to the seat upholstered element and/or the carriage in order to keep the seat upholstered element under tension. A tensile force is applied to the carriage and/or the seat upholstered element via a tension belt which is attached to the frame of the seat cushion. As a result of the different coupling and/or guiding of the tension belt in comparison to the seat upholstered element, said belt and said element travel different distances when the sitting position is adjusted. In order to compensate these differences, the tension belt can have a spring or a rubber belt.

In one advantageous embodiment there is provision for the tension belt to have a deflection device which is connected to the inclination adjusting device of the lower leg rest and/or the seat cushion depth adjusting device and is designed to compensate the different distances. For example, a force which is constant in all the sitting positions can be applied to the seat upholstered element, and preferably a constant abutment of the seat upholstered element can be achieved.

In one embodiment, the seat cushion has a two-component frame which supports the seat upholstered element. A fixed securing frame is permanently connected to the seat upholstered element and supports a supporting profile which can be retracted or extended in order to adjust the sitting depth. By retracting and extending the supporting profile it is possible to set the sitting depth, and thus adapt it in an optimum fashion to the length of the thigh of the sitting person. The lower leg rest is pivotably mounted on the supporting profile. Said lower leg rest directly adjoins the sitting surface so that a continuous and/or uninterrupted support of the upper and lower parts of the leg is ensured.

In order to comfortably support the lower leg, there is provision for the length and the inclination of the lower leg rest to be adjustable. The lower leg rest can be embodied as a lower leg rest which can be adjusted in a telescopic fashion. Its length can be varied by means of an electric spindle drive and thus adapted to the length of the lower leg. By adjusting the inclination, the sitting person can select the height and/or inclination of the lower leg rest which is pleasant for him.

When the seat cushion depth and/or the length and/or inclination of the lower leg rest are set in an optimum fashion there is provision for the pivot point of the lower leg rest, which is arranged on the supporting profile of the seat cushion, to correspond to the knee joint of the sitting person. As a result, the legs can be supported over their entire length.

It is possible to use the vehicle seat according to the invention in passenger cars, buses and watercraft or rail vehicles. There is also provision for the vehicle seat according to the invention to be used as a comfortable passenger seat in aircraft.

Further features and embodiments of the invention emerge from the claims, the figures and the description of the figures. The features and combinations of features which are mentioned above and specified below can be used not only in the respectively given combination but also in other combinations or alone without departing from the scope of the invention.

Other objects, advantages and novel features of the present invention will become apparent from the following detailed description of the invention when considered in conjunction with the accompanying drawings.

### BRIEF DESCRIPTION OF THE DRAWINGS

FIG. 1: is a view of the vehicle seat in accordance with an embodiment of the present invention in an upright sitting position,

FIG. 2: is a view of the vehicle seat of FIG. 1 in the lying position,

FIG. 3: is a schematic side view of the vehicle seat of FIG. 1 with a sitting person

FIG. 4: is a view of the seat cushion frame of the vehicle seat of FIG. 1,

FIG. 5: is a view of the lower leg rest of the vehicle seat of FIG. 1,

FIG. 6: is a view of the telescopic drive of the vehicle seat of FIG. 1 with the lower leg rest retracted,

FIG. 7: is a view of the telescopic drive of the vehicle seat of FIG. 1 with the lower leg rest extended, and

FIGS. 8-11: are each views of the deflection device with the tension belt of an embodiment of the present invention in various positions.

### DETAILED DESCRIPTION

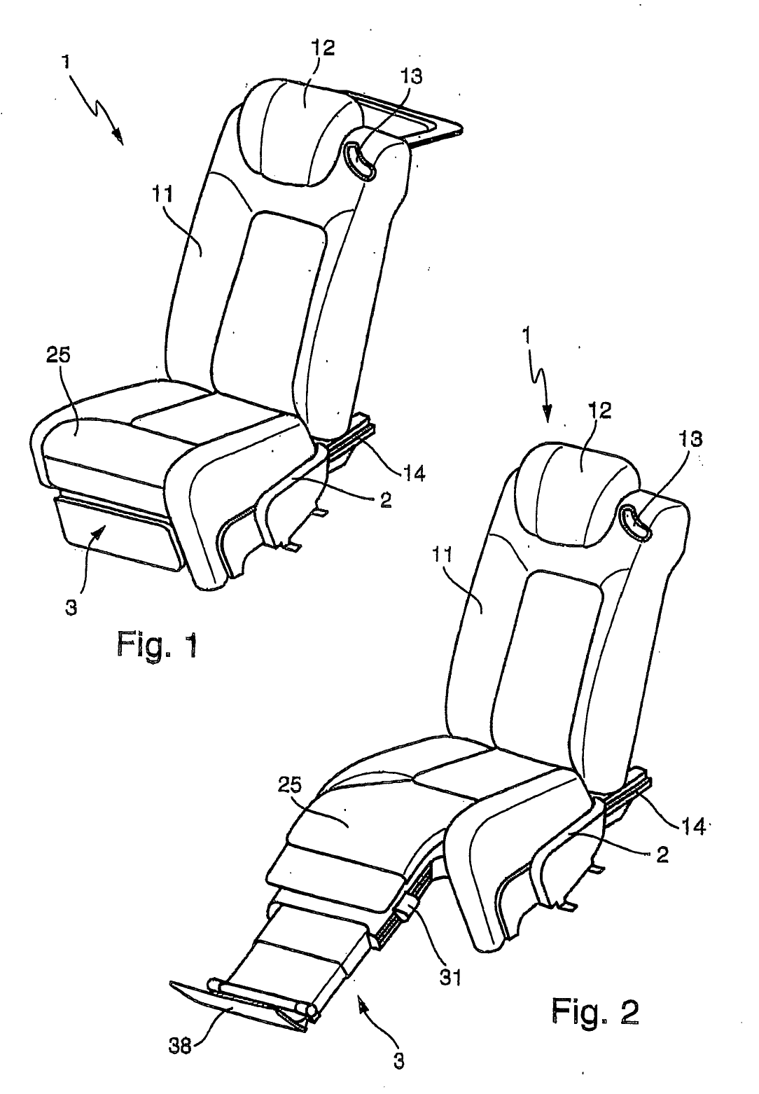

FIG. 1 shows an embodiment of the vehicle seat 1 in an upright sitting position. It has a backrest 11 with head rest 12 and a seat cushion 2 with lower leg rest 3. The vehicle seat 1 is displaceably mounted in a vehicle, for example in the rear of a passenger car, by means of rails 14. A seat belt mount 13 for a three-point belt is integrated in the backrest 11. The backrest 11 and the seat cushion 2 have an upholstered element with a cover made of leather. The seat cushion upholstered element 25 upholsters the seat cushion and the lower leg rest 3 and is of continuous design. It forms an uninterrupted, upholstered sitting surface. In the upright sitting position illustrated, the lower leg rest 3 is arranged resting against the front region of the seat cushion in a space-saving fashion. This stowaway position does not adversely affect the footspace available in the vehicle.

FIG. 2 shows the vehicle seat 1 in a resting position or lying position. The vehicle seat 1 has been moved forward on the rails 14 in comparison with the view in FIG. 1 in order to acquire space for the pivoting back of the backrest 11. The lower leg rest 3 is moved forward into a position of use in this view. It has been pivoted forward and upward and extended in order to form a good support for the lower legs. A footplate 38 is arranged at the lower end of the lower leg rest 3. It is followed out in the position of use and provides a comfortable support to the feet. The upholstered element 25 upholsters the seat cushion 2 and the lower leg rest 3. It is attached by one end to the seat cushion and by the other end to a carriage 31 which is displaceably guided on the lower leg rest 3. It has a continuous and gap-free upholstered surface which is structured only by the stitching of the covering material.

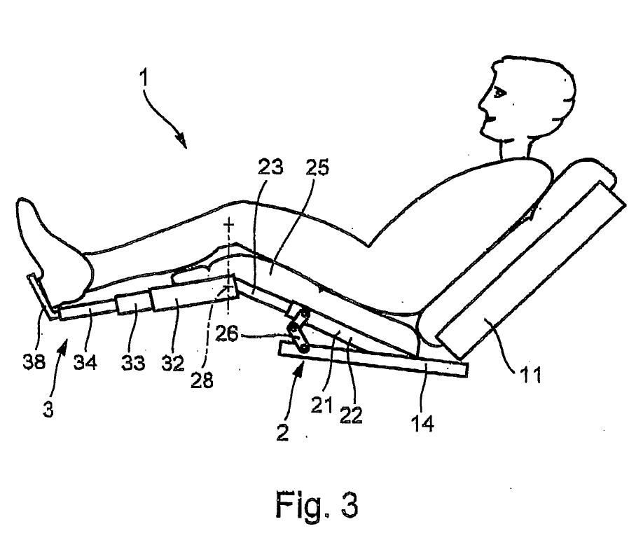

The schematic illustration in FIG. 3 shows the resting position and/or lying position of the vehicle seat 1. The backrest 11 is pivoted back about an axis which is arranged transversely with respect to the sitting surface. The sitting surface of the seat cushion 2 is inclined upward by virtue of the fact that a seat cushion inclination adjusting device 26 which engages between the rail 14 and a seat cushion frame 21 has raised the front end of the seat cushion 2. The lower leg rest 3 is arranged directly adjoining the front end of the seat cushion 2. It has a three-part telescopic component 32, 33, 34 which can be extended in order to support the lower legs. An extendable footplate 38, which is designed to support the feet, is arranged at the lower end of the lower leg rest 3.

For the optimum sitting position shown in FIG. 3, the length of the lower leg rest 3 is adapted to the length of the lower legs. In addition, the seat cushion depth is adapted to the length of the thighs. The pivot point of the knees is above the pivot point 28 of the lower leg rest 3. The back is resting against the backrest 11. The vehicle seat 1 matches the anatomy of the body by virtue of the fact that, on the one hand, the sitting surface can be adapted to the length of the upper and lower legs and, on the other hand, the pivot point 28 of the lower leg rest 3 and the knee as well as the pelvis support corresponds to, or can be matched to, the anatomy of the sitting person. As a result, the body is supported in an optimum fashion and the vehicle seat 1 has a large supporting surface for the body. Relatively small and/or relatively large persons can easily set the sitting position which is optimum for them by means of the automatically driven adjustment of the sitting depth and/or the length of the lower leg rest 3.

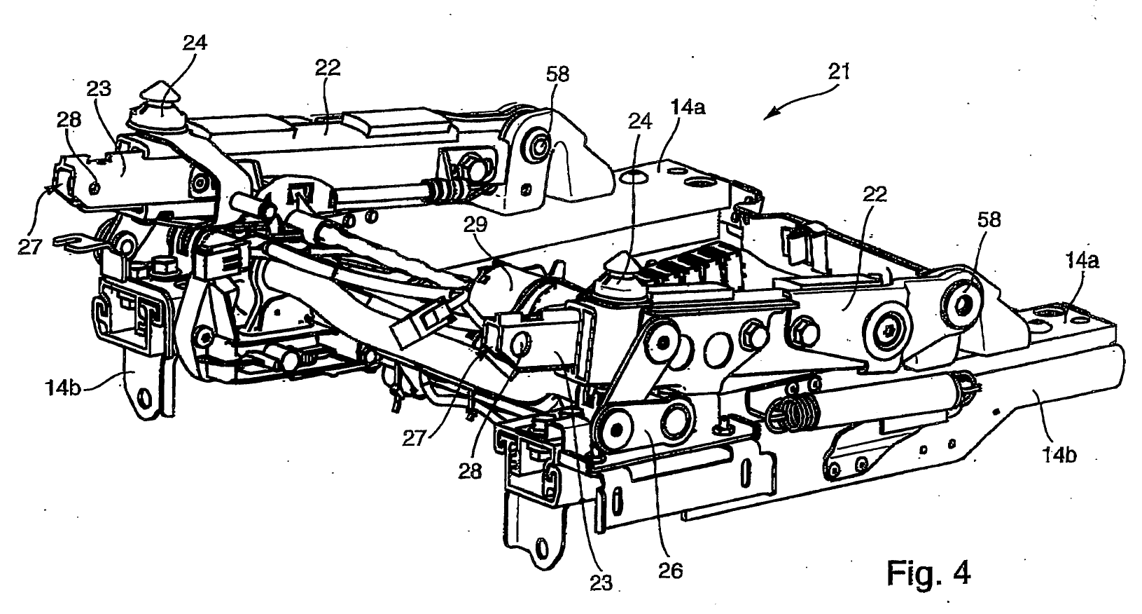

The seat cushion frame 21 is represented in detail in FIG. 4. It is divided up into a plurality of components and has a securing frame 22 on the left-hand and right-hand sides respectively, which frames 22 are pivotably mounted on the rail 14 by means of a rotary bearing 58. The securing frame 22 in turn supports a supporting profile 23 which can be moved linearly in order to adjust the sitting depth. The rail 14 which is arranged on both sides of the seat is of two-part design in each case and has a lower part 14b which is permanently screwed to the vehicle, and a displaceable upper part 14a. Each upper part 14a secures a securing frame 22 by means of a rotary bearing 58.

The securing frame 22 has a profile which engages around the supporting profile 23 in a positively locking fashion. The supporting profile can be retracted into the securing frame 22 or extended out of the securing frame 22 driven by an electric drive motor 29 in order to adjust the seat cushion depth. The supporting profile has, at its front end, a mount 27 in which the lower leg rest 3 is rotatably attached. The mounts 27 of the two supporting profiles 23 form the axis 28 of rotation of the lower leg rest 3. As a result, on the one hand, the lower leg rest 3 is arranged directly adjoining the seat cushion 2, and, on the other hand, it is ensured that when the seat cushion depth and/or the seat cushion inclination are adjusted, the axis 28 of rotation of the lower leg rest 3 is also adjusted.

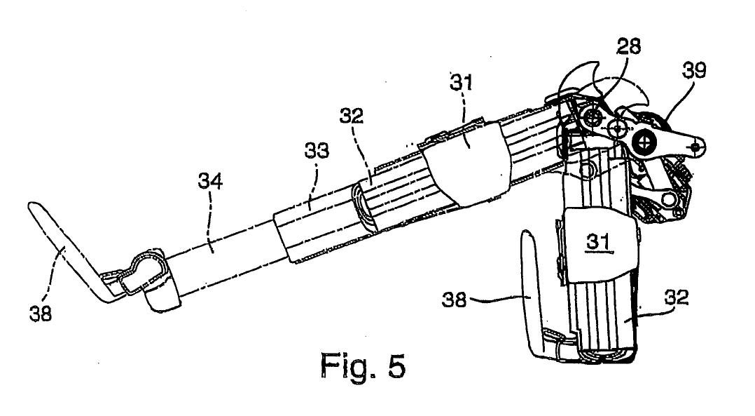

FIG. 5 shows the lower leg rest 3, on the one hand, in a stowaway position with retracted telescopic component 32, 33, 34 and, on the other hand, in the position of use with extended telescopic component 32, 33, 34. The lower leg rest 3 is pivotably connected to the mount 27 of the supporting profile 23 by means of an electrically driven pivoting device 39. Said lower leg rest 3 has a three-part telescopic component with an upper telescopic element 32, a central telescopic element 33 and a lower telescopic element 34. The footplate 38 is swivelably attached to the lower telescopic element 34. The telescopic elements are embodied and dimensioned in such a way that they can largely be moved one into the other, the uppermost telescopic element 32 holding the others. In this way, the lower leg rest 3 requires only a small stowaway space in the stowaway position and at the same time has a large usable length in the position of use. The upper telescopic element 31 has laterally arranged guides which secure the carriage 31. The upper side of the carriage 31 which faces the seat upholstered element 25 has coupling elements for attaching the seat upholstered element 25. The carriage 31 is connected to a tension belt 55 which applies a force to the carriage 31 which is as constant as possible and is directed toward the footplate, in order to clamp the seat upholstered element 25.

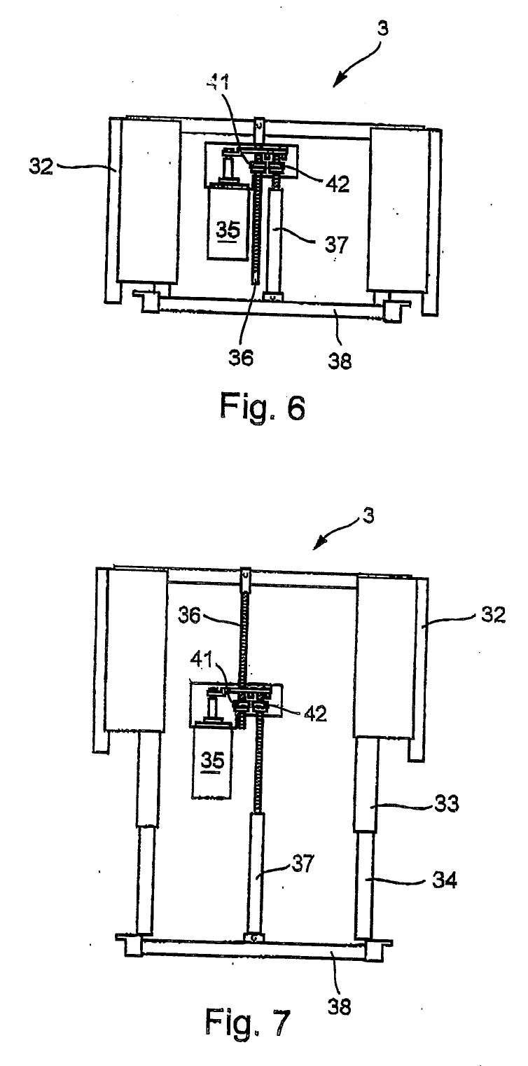

In order to be able to adjust the length of the lower leg rest 3 easily and comfortably, the latter has an electric drive. FIG. 6 shows this drive with the telescopic component retracted, and FIG. 7 shows it with the telescopic component extended. The drive is embodied as a spindle drive and has an electric drive motor 35 which drives a first spindle drive 36 and a second spindle drive 37. The drive is connected via a bridge to the central telescopic element 33. The first spindle drive 36 engages between the central telescopic element 33 and the upper telescopic element 32, and the second spindle drive 37 engages between the central telescopic element 33 and the lower telescopic element 34. The upper telescopic element 32 and the lower telescopic element 34 are moved synchronously away from the central telescopic element 33 or toward the central telescopic element 33 by the spindle drive 36, 37.

The electric drive motor 35 drives, via a gear mechanism, a first spindle nut 41 which is connected to the first spindle drive. This first spindle nut 41 intermeshes with a second spindle nut 42 which is connected to the second spindle drive 37. By means of the intermeshing spindle nut, the electric motor 35 drives the second spindle drive 37 in the opposite sense of rotation to the first spindle drive 36. As a result, the electric motor 35 drives the telescopic elements 32, 33, 34 in such a way that in one sense of direction the upper telescopic element 32 and the lower telescopic element 34 are driven away from the central telescopic element 33, and in the opposite sense of direction the upper telescopic element 32 and the lower telescopic element 34 are driven toward the central telescopic element 33.

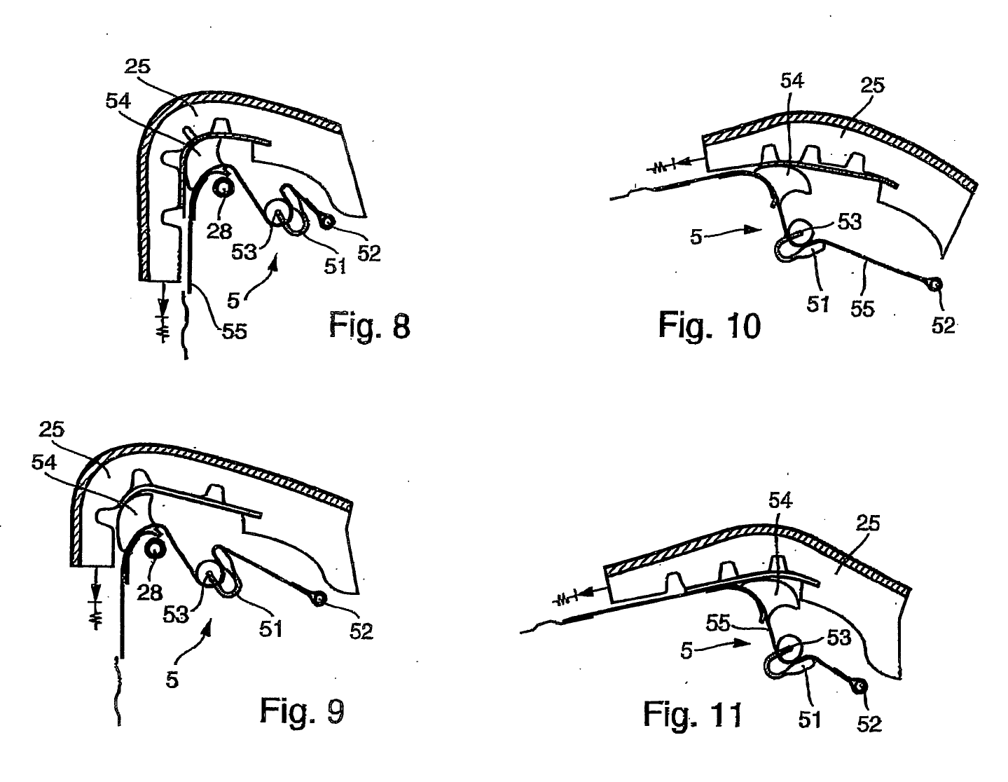

FIGS. 8 to 11 show the deflection device 5 which guides the tension belt 55. One end of the tension belt 55 is connected to the carriage 31. The other end of the tension belt 55 is attached to the securing frame 22 of the seat cushion 2 at a fixed point 52. The tension belt 55 applies a constant force to the carriage 31 and thus to the seat upholstered element 25, in order to clamp the seat upholstered element 25 in a defined fashion. When the seat depth and/or the lower leg rest length and/or lower leg rest inclination are adjusted, the seat upholstered element 25 moves in relation to the seat frame. So that a constant force for clamping the seat upholstered element 25 can be applied in different sitting positions, the tension belt must be adjusted at the same time. Since the tension belt 55 is guided over different amounts of travel within the seat, the deflection device has a compensation lever 51 which is mounted so as to rotate about an axis 53 of rotation. This compensation lever 51 is connected to the inclination adjusting device 39 of the lower leg rest 3 and compensates the different amounts of travel of the seat upholstered element 25 and tension belt 55 when the lower leg rest 3 is inclined about the pivot axis 28. For this purpose the compensation lever 51 is pivoted about the axis 53 of rotation as a function of the inclination angle of the lower leg rest 3, and in doing so it takes up a greater or lesser amount of belt slack from the tension belt 55.

FIG. 8 shows the deflection device 5 with a small sitting depth and the lower leg rest 3 pivoted downward in a stowaway position. In FIG. 9 the lower leg rest 3 is in the stowaway position, as in FIG. 8, but here the sitting depth is increased. The supporting profile is extended and it displaces a deflection upholstered element 54, which supports the seat upholstered element 25, in such a way that a larger sitting depth is produced. Since there is no difference in travel between the tension belt 55 and the seat upholstered element 25 during linear displacement, the compensation lever 51 is also displaced linearly by the same amount of travel as the supporting upholstered element 54.

In contrast, FIG. 10 shows the deflection device 5 with the lower leg rest 2 pivoted up and with a large sitting depth. Here, the compensation lever 51 is pivoted about the axis 53 of rotation. In this way, the difference in travel, which arises owing to different curve radii of the seat upholstered element 25 and tension belt 55, is compensated. FIG. 11 shows the deflection device 5 with the lower leg rest 2 pivoted up and with a small sitting depth. Since there is no difference in travel here between the seat upholstered element 25 and tension belt 55 owing to the purely linear movement, the compensation lever 51 is displaced linearly together with the supporting upholstered element 54 by the supporting profile 23.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A reclinable vehicle seat, which has an upright sitting position and a reclined resting position and which can be adjusted in an infinitely variable fashion, between the sitting position and the resting position, having a backrest whose inclination can be adjusted, and having a seat cushion with adjustable sitting depth and a lower leg rest, wherein the inclination of the seat cushion can be adjusted by a seat cushion inclination adjusting device, and seat cushion has a continuous seat upholstered element which is designed to upholster the seat cushion and the lower leg rest, the lower leg rest being adjustable and having a space-saving stowaway position and a position of use.

2. The vehicle seat as claimed in claim 1, wherein at least one of the lower leg rest inclination and length is adjustable in relation to the seat cushion.

3. The vehicle seat as claimed in claim 1, wherein the seat upholstered element is secured at one of its ends to the seat cushion, and is connected at its other end to the lower leg rest by a displaceably mounted carriage.

4. The vehicle seat as claimed in claim 1 wherein the seat upholstered element has an enclosed upholstered surface.

5. The vehicle seat as claimed in claim 1 wherein the seat cushion has a two-component frame, having a fixed securing frame which is connected to the seat upholstered element and a supporting profile extendable linearly in order to adjust the sitting depth.

6. The vehicle seat as claimed in claim 5, wherein the securing frame supports the supporting profile in such a way that the supporting profile is retractable into a profile of the securing frame.

7. The vehicle seat as claimed in claim 5 the lower leg rest is pivotably mounted at one end of the supporting profile, such that the inclination of the lower leg rest can be adjusted.

8. The vehicle seat as claimed in claim 1, wherein the lower leg rest has a telescopic component with a plurality of telescopic elements, and the length of the lower leg is telescopically adjustable by a telescopic drive.

9. The vehicle seat as claimed in claim 8, wherein the telescopic drive has an electric motor which is arranged in one of the plurality of telescopic elements and drives an upper one of the telescopic elements by a first spindle drive, and a one of the lower telescopic elements by a second spindle drive.

10. The vehicle seat as claimed in claim 9, wherein in one direction of rotation, the electric motor drives the upper telescopic element and the lower telescopic element away from a central telescopic element, and in the opposite direction it drives the upper telescopic element and the lower telescopic element toward the central telescopic element.

11. The vehicle seat as claimed in claim 10, wherein the electric motor drives a first spindle nut of the first spindle drive in a first direction and the first spindle nut intermeshes in the opposite direction with a second spindle nut of the second spindle drive, such that the electric motor drives the first spindle drive in the opposite direction to the second spindle drive.

12. The vehicle seat as claimed in claim 1, wherein the seat upholstered element is coupled to the carriage of the lower leg rest, and the carriage is connected to the seat cushion frame via a tension relief belt arranged to clamp the seat upholstered element.

13. The vehicle seat as claimed in claim 12, wherein the tension relief belt is guided by a deflection device which is arranged to apply an approximately constant force to the carriage in all the sitting positions.

14. The vehicle seat as claimed in claim 12, wherein the deflection device has a pivotable compensation lever which compensates the relative movement between the tension relief belt and the seat upholstered element.

15. The vehicle seat as claimed in claim 14, wherein the lower leg rest has an automatically driven inclination adjusting device which is pivotably connected to the lower leg rest and to the supporting profile, and the inclination adjusting device automatically adjusts the inclination of the lower leg rest.

16. The vehicle seat as claimed in claim 15, wherein the compensation lever is connected to the inclination adjusting device of the lower leg rest.
